(19) United States
(12) Patent Application Publication
(10) Pub. No.: US 2013/0104713 A1
(43) Pub. Date: May 2, 2013

(54) CUTTING APPARATUS

(71) Applicant: BROTHER KOGYO KABUSHIKI KAISHA, Nagoya-shi (JP)

(72) Inventors: Yasuhiko Kawaguchi, Nagoya-shi (JP); Tomoyasu Niizeki, Ichinomiya-shi (JP); Yoshinori Nakamura, Toyohashi-shi (JP); Masahiko Nagai, Nagoya-shi (JP)

(73) Assignee: BROTHER KOGYO KABUSHIKI KAISHA, Nagoya-Shi (JP)

(21) Appl. No.: 13/626,200

(22) Filed: Sep. 25, 2012

(30) Foreign Application Priority Data
Oct. 26, 2011 (JP) 2011-235014

(51) Int. Cl. B26D 5/02

(52) U.S. Cl. 83/76.1

(57) ABSTRACT

A cutting apparatus in which a cutting blade and an object to be cut are moved relative to each other based on cutting data set in the apparatus so that the object is out into a desired shape by the cutting blade. The apparatus includes an angle change unit which is configured to change an angle made by the cutting blade and the object. In the apparatus, the angle change unit is configured to change the angle between a first angle during a non-cutting time and a second angle at which the cutting unit is tilted during a cutting time so that the second angle is rendered smaller than the first angle.

### CROSS-REFERENCE TO RELATED APPLICATIONS

This application is based upon and claims the benefit of priority from the prior Japanese Patent Application No. 2011-235014 filed on Oct. 26, 2011, the entire contents of which are incorporated herein by reference.

### BACKGROUND

1. Technical Field

The present disclosure relates to a cutting apparatus in which a cutting blade and an object to be cut are moved relative to each other so that the object is out into a desired shape.

2. Related Art

There has conventionally been known a cutting plotter which automatically cuts a sheet such as paper, for example. The sheet is affixed to a base material serving as a holding member having an adhesive layer on a surface thereof. The cutting plotter includes a drive mechanism having a pair of rollers which are vertically disposed and hold both ends of the base material therebetween so that the object is moved in a first direction. The cutting apparatus also includes a cutter holder which supports a cutting blade and is moved in a second direction perpendicular to the first direction, whereby the sheet is cut.

FIG. 11 schematically illustrates a commonly-used cutter (a cutting blade) 100 and a cutter holder 101 both employed in conventional cutting plotters. As shown, the cutter 100 is fixed to a lower end of a bar-like cutter shaft 102 by a screw 103. The cutter shaft 102 is mounted on a bearing 101 so as to be rotatable about an axis O. The bearing 104 is provided in a recess 101a formed in a lower end of the cutter holder 101. The cutter 100 includes a blade portion 100a which is located so that a lowermost end blade edge 100b thereof is offset by distance d relative to the axis O. Accordingly, when the sheet 105 is cut by the cutter 100 with the movement of the cutter 100 and the sheet 105 relative to each other, the blade edge 100b of the cutter 100 is subjected to resistance (reactive force) such that the cutter shaft 102 is rotated about the axis O. More specifically, the direction of the blade edge 100b of the cutter 100 is automatically changed according to a direction in which the cutter 100 and the sheet 105 are moved relative to each other.

The resistance to which the blade edge 100b of the cutter 100 is subjected is rendered large when cutting is executed by the cutting plotter. In order that the load applied to the cutter 100 may be rendered smaller for improvement in the sharpness of the cutter 100, an angle α between the blade 100a of the cutter 100 and the sheet 105 has been suggested to be set to a small value.

On the other hand, when a cutting line of the sheet 105 includes a corner, which is cut by the cutter 100, the cutter 100 is rotatively moved so as to slightly pry or twist a distal end of the corner, whereby the direction of the blade edge 100b is changed. Accordingly, the angle α is desirable to be set to a large value. Thus, the cutter 100 has conflicting advantages and disadvantages when the angle α is set to both a small value and a large value, respectively. It is desirable to simultaneously overcome the disadvantages in the two cases.

### SUMMARY

Therefore, an object of the disclosure is to provide a cutting apparatus which can improve the sharpness of the cutter during the cutting operation and which can suitably move the cutting blade and the object relative to each other.

The present disclosure provides a cutting apparatus in which a cutting blade and an object to be cut are moved relative to each other based on cutting data set therein so that the object is cut into a desired shape by the cutting blade. The apparatus includes an angle change unit which is configured to change an angle made by the cutting blade and the object, wherein the angle change unit is configured to change the angle between a first angle during a non-cutting time and a second angle at which the cutting unit is tilted during a cutting time so that the second angle is rendered smaller than the first angle.

### BRIEF DESCRIPTION OF THE DRAWINGS

In the accompanying drawings:

FIG. 1 is a perspective view of the cutting apparatus according to one embodiment, showing an inner structure thereof;

FIG. 2 is a plan view of the cutting apparatus;

FIG. 3 is a perspective view of a cutter holder;

FIG. 4 is a sectional view of the cutter holder, showing the case where the cutter has been ascended;

FIG. 5 is a side view of the cutter holder and its vicinity, showing the case where the cuter has been descended;

FIG. 6 is an enlarged front view of a gear;

FIG. 7 is a block diagram showing an electrical arrangement of the cutting apparatus;

FIGS. 8A, 8B and 8C are enlarged left side, front and right side views of the cutter and its mounting structure respectively;

FIGS. 9A and 9B are similar to FIG. 8B, showing the cutter and an object to be cut during non-cutting and cutting respectively;

FIG. 10 illustrates an example of a cutting line of the object; and

FIG. 11 is an enlarged sectional view of the distal end of a cutter holder commonly used in conventional cutting plotters.

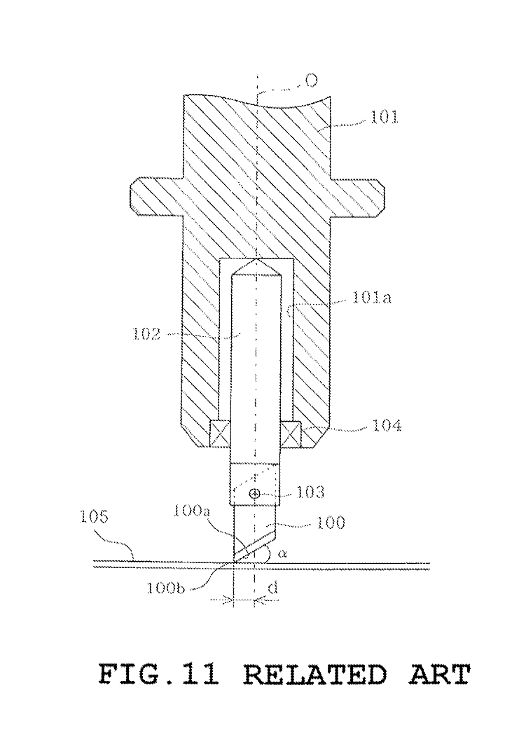

### DETAILED DESCRIPTION

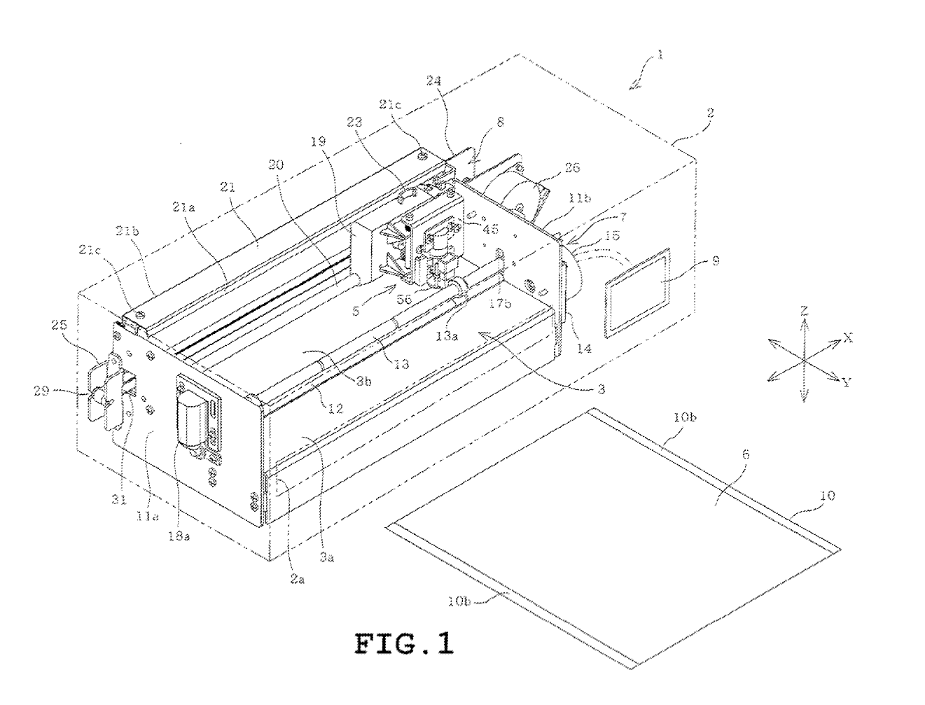

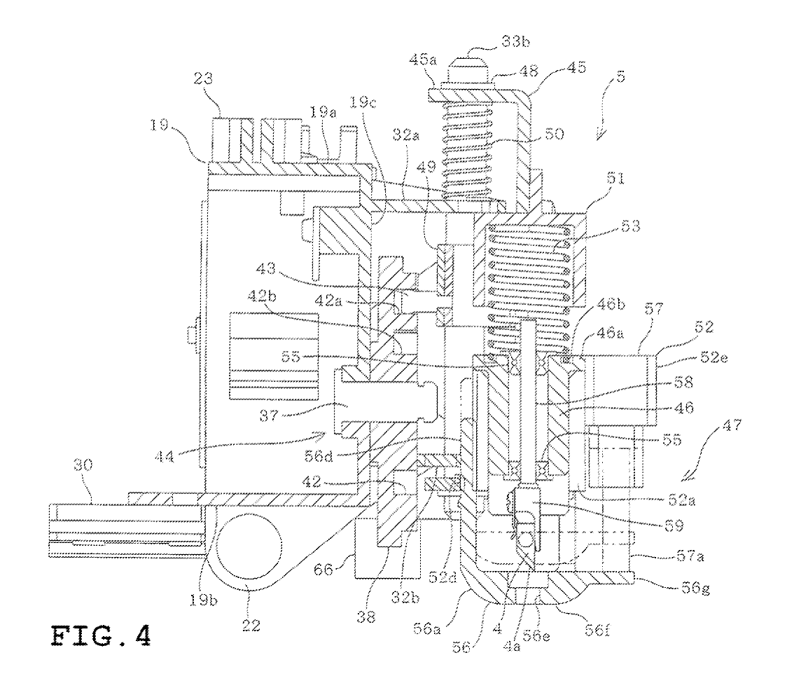

One embodiment will be described with reference to FIGS. 1 to 10. Referring to FIG. 1, a cutting apparatus 1 includes a body cover 2 as a housing, a platen 3 provided in the body cover 2 and a cutter holder 5 also provided in the body cover 2. The cutting apparatus 1 also includes first and second moving units 7 and 8 for moving a cutter 4 (see FIG. 4) of the cutter holder 5 and an object 6 to be cut, relative to each other. The body cover 2 is formed into the shape of a horizontally long rectangular box and has a front formed with a horizontally long opening 2a which is provided for setting a holding sheet 10 holding the object 6. In the following description, a direction in which the object 6 is moved by the first moving unit 7 will be referred to as “front-back direction” and more specifically, the side of the cutting apparatus 1 where the opening 2a is located will be referred to as “front” and the opposite side will he referred to as “back.” The front-back direction will be referred to as “Y direction.” The right-left direction perpendicular to the Y direction will be referred to as “X direction.”

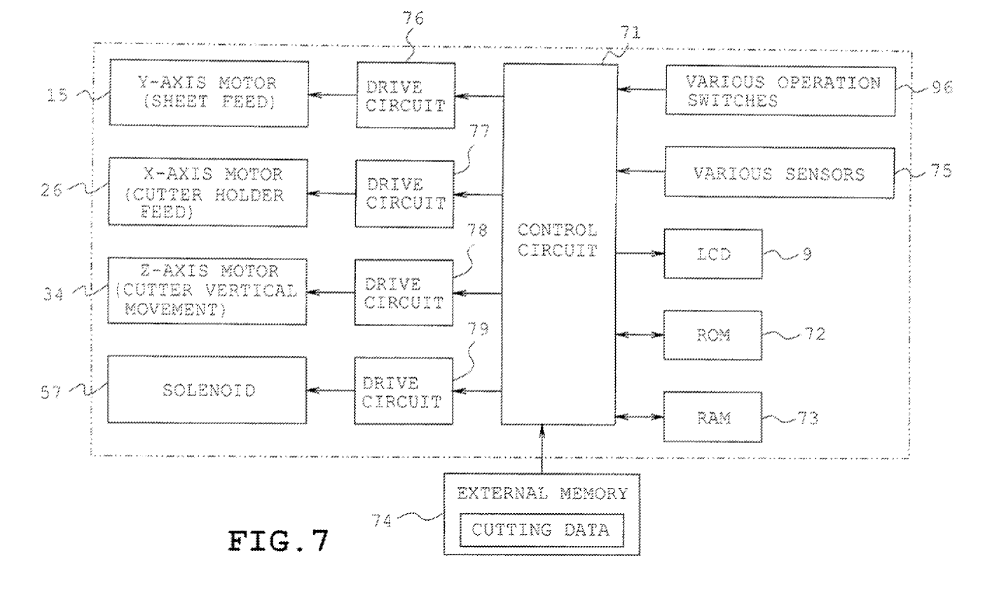

On a right part of the body cover 2 are provided a liquid crystal display (LCD) 9a and a plurality of operation switches 9b (see FIG. 7). The LCD 9a serves as a display unit displaying messages and the like necessary for the user. The operation switches 9b serve as input units for the user to supply various instructions, selections and inputs to the cutting apparatus 1.

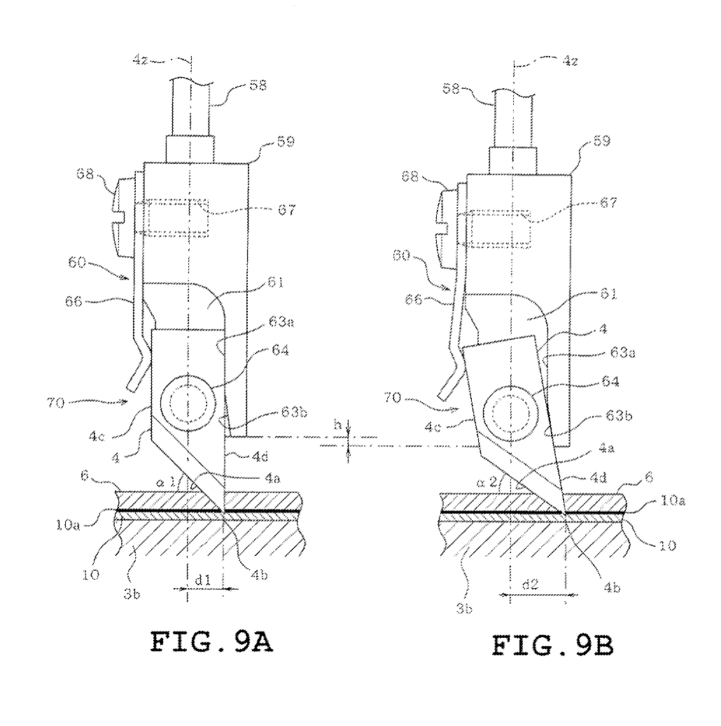

The platen 3 includes a pair of front and rear plate members 3a and 3b and has an upper surface which is configured into an X-Y plane serving as a horizontal plane. The platen 3 is set so that the holding sheet 10 holding the object 6 is placed thereon. The holding sheet 10 is received by the platen 3 when the object 6 is cut. The holding sheet 10 has an upper surface with an adhesive layer 10a (see FIG. 9A) formed by applying an adhesive agent to a part thereof except for right and left edges 10b. The object 6 is affixed to the adhesive layer 10a thereby to be held.

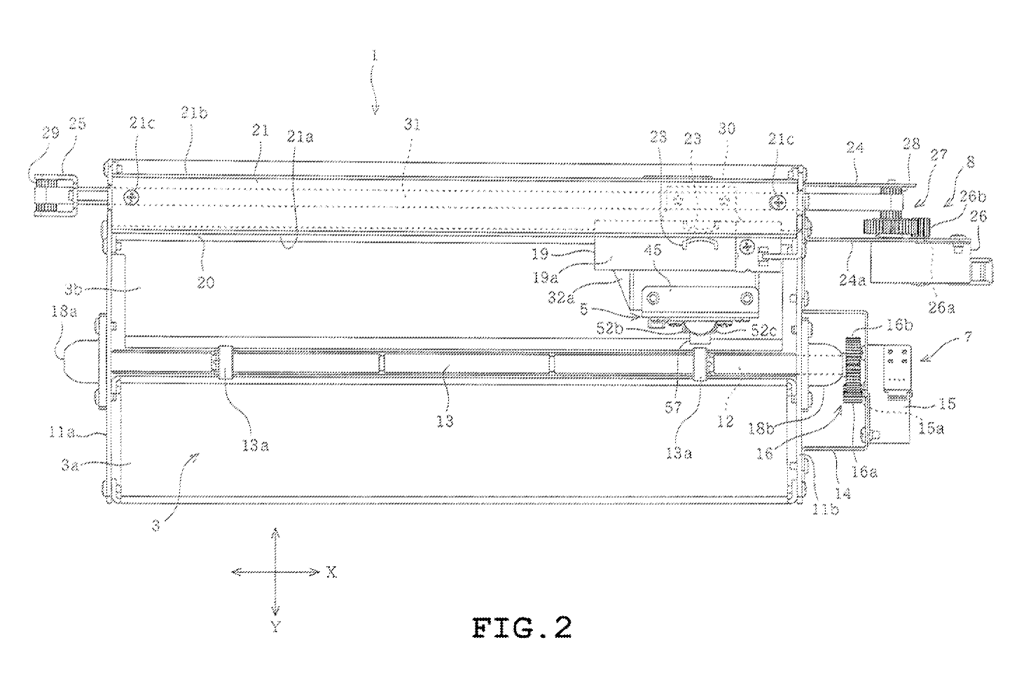

The first moving unit 7 moves the holding sheet 10 on the upper surface side of the platen 3 in the Y direction (a first direction). More specifically, a driving roller 12 and a pinch roller 13 are provided on right and left sidewalls 11b and 11a so as to be located between plate members 3a and 3b of the platen 3. The driving roller 12 and the pinch roller 13 extend ill the X direction and are rotatably supported on the sidewalls 11b and 11a. The driving roller 12 and the pinch roller 13 are disposed so as to be parallel to the X-Y plane and so as to be vertically arranged. The driving roller 12 is located above the pinch roller 13. A first crank-shaped mounting frame 14 is mounted on the right sidewall 11b so as to be located on the right of the driving roller 12 as shown in FIG. 2. A Y-axis motor 15 is fixed to an outer surface of the mounting frame 14.

The Y-axis motor 15 comprises a stepping motor, for example and has a rotating shaft 15a extending through a hole not shown) of the first mounting frame 14 and further has a distal end provided with a gear 16a. The driving roller 12 has a right end to which is secured another gear 16b which is brought into mesh engagement with the gear 16a. These gears 16a and 16b constitute a first reduction gear mechanism 16. The pinch roller 13 is guided by guide grooves 17b formed in the right and left sidewalls 11b and ha so as to be movable upward and downward. Only the right guide groove 17b is shown in FIG. 1. Two spring accommodating members 18a and 18b are mounted on the right and left sidewalls 11b and 11a in order to cover the guide groove 17b from the outside respectively. The pinch roller 13 is biased downward by compression coil springs (not shown) accommodated in the spring accommodating portions 18a and 18b respectively. The pinch roller 13 is provided watt pressing portions 13a which are brought into contact with both right and left edges 10b of the holding sheet 10, thereby pressing the edges 10b, respectively. Each pressing portion 13a has a slightly larger outer diameter than the other portion of the pinch roller 13.

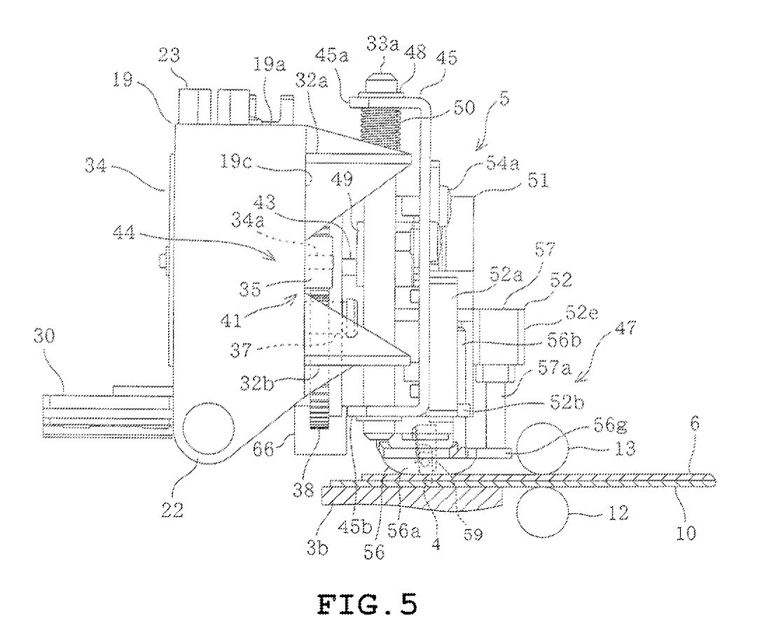

The driving roller 12 and the pinch roller 13 press the holding sheet 10 from below and from above by the biasing force of the compression coil springs thereby to hold the holding sheet 10 therebetween (see FIG. 5). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the object 6. The first moving unit is thus constituted by the driving roller 12, the pinch roller 13, the Y-axis motor 15, the first reduction gear mechanism 16, the compression coil springs and the like.

The second moving unit 8 moves a carriage 19 supporting the cutter holder 5 in the X direction (a second direction). The second moving unit 8 will be described in more detail. A guide shaft 20 and a guide frame 21 both extending in the right-left direction are provided between the right and left sidewalls 11b and 11a so as to be located at the rear end of the cutting apparatus 1, as shown in FIGS. 1 and 2. The guide shaft 20 is disposed in parallel with the driving roller 12 and the pinch roller 13. The guide shaft 20 located right above the platen 3 extends through a hole of a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting apparatus 1, and an auxiliary frame 25 is mounted on the left sidewall 11a in the rear of the cutting apparatus 1, as shown in FIG. 2. An X-axis motor 26 and a second reduction gear mechanism 27 are mounted on the second mounting frame 24. The X-axis motor 26 comprises a stepping motor, for example and is fixed to a front of a front mounting piece 24a. The X-axis motor 26 includes a rotating shaft 26a which extends through a hole (not shown) of the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 connected to a rear end (a mourning portion 30 as will be described later) of the carriage 19 extends between the pulleys 28 and 29.

Upon drive of the X-axis motor 26, normal or reverse rotation of the X-axis motor 26 is transmitted is the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction perpendicular to the Y direction in which the object 6 is conveyed. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

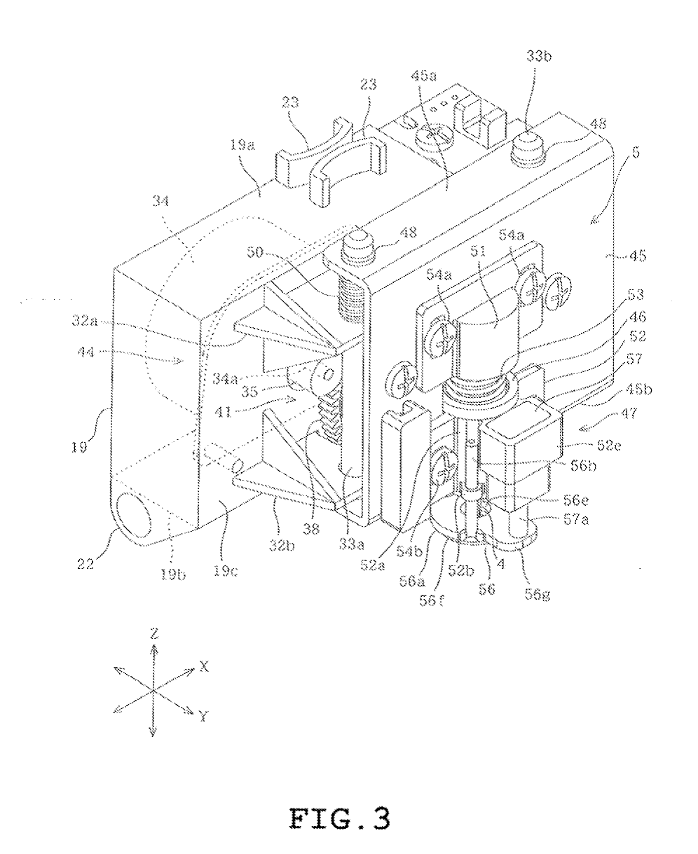

The cutter holder 5 is disposed on the front of the carriage 19 and is supported so as to be movable in a vertical direction (a third direction) serving as a Z direction. The carriage 19 and the cutter holder 5 will be described with reference to FIGS. 3 to 6 as well as FIGS. 1 and 2. The carriage 19 is formed into the shape of a substantially rectangular box with an open rear as shown in FIGS. 2 and 3. The carriage 19 has an upper wall 19a with which a pair of upwardly protruding front and rear guided members 23 are integrally formed. The guided members 23 are arc-shaped ribs as viewed in a planar view. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted, as shown in FIG. 4. An attaching portion 30 (see FIGS. 4 and 5) is mounted on the bottom wall 19b of the carriage 19 so as to protrude rearward. The attaching portion 30 is to be coupled with the timing belt 31. The carriage 19 is thus supported by the guide shaft 20 inserted through the holes 22 so as to be slideable in the right-left direction and further supported by the guide frame 21 held between the guided members 23 so as to be prevented from being rotated about the guide shaft 20.

The carriage 19 has a front wall 19c with which a pair of upper and lower support portions 32a and 32b are formed so as to extend forward as shown in FIGS. 3 to 5, etc. A pair of right and left support shafts 33b and 33a extending through the respective support portions 32a and 32b are mounted on the carriage 19 so as to be vertically movable. A Z-axis motor 34 comprising, for example, a stepping motor is accommodated in the carriage 19 backward thereby to be housed therein. The Z-axis motor 34 has a rotating shaft 34a (see FIGS. 3 and 5) which extends through a hole (not shown) of the front wall 19c of the carriage 19. The rotating shaft 34a has a distal end provided with a gear 35. Furthermore, the carriage 19 is provided with a gear shaft 37 which extends through a hole (not shown) formed in a slightly lower part of the gear 35 relative to the central part of the front wall 19c as shown in FIGS. 5, 6 and 9. A gear 38 is rotatably mounted on the gear shaft 37 and adapted to be brought into mesh engagement with the gear 35 in front of the front will 19c is rotatably mounted on the gear shaft 37. The gear 38 is retained by a retaining ring (not shown) mounted on a front end of the gear shaft 37. The gears 35 and 38 constitute a third reduction mechanism 41 (see FIGS. 3 and 5).

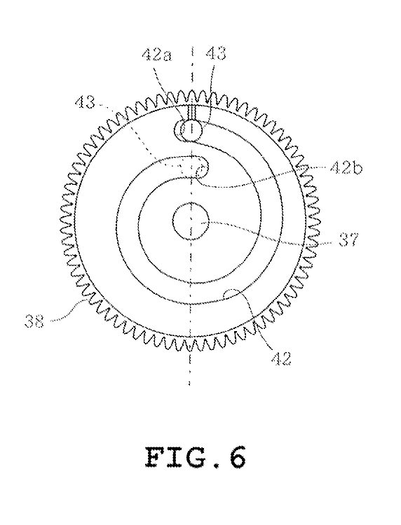

The gear 38 is formed with a spiral groove 42 as shown in FIG. 6. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder engages the spiral groove 42 (see FIG. 4) as will be described in detail later. Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cutter holder 5 is moved upward or downward together with the support shafts 33a and 33b. In this case, the cutter holder 5 is moved between a raised position (see FIGS. 4 and 6) where the engagement pin 43 is located at the first end 42a of the spiral groove 42 and a lowered position (see FIGS. 5 and 6) where the engagement pin 43 is located at the second end 42b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 provided on the support shafts 33a and 33b, a movable cylindrical portion 46 which has a cutter 4 (a cutting blade) and is held by the holder body 45 so as to be vertically movable and a pressing device 47 which presses the object 6. More specifically, the holder body 45 has an upper end 45a and a lower end 45b both of which are folded rearward such that the holder body 45 is generally formed into a O-shape, as shown in FIGS. 3 to 5, etc. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a rearwardly directed engagement pin 43 as shown in FIGS. 4 and 5. The holder body 45, the support shafts 33a and 33b, the engagement pin 43 and the coupling member 49 are formed integrally with one another. The cutter holder 5 is vertically moved by the third moving unit 44 in conjunction with the engagement pin 43. Furthermore, two compression coil springs 50 serving as biasing members are mounted about the support shafts 33a and 33b so as to be located between upper surfaces of the support portion and an upper end of the holder body 45, respectively. The entire cutter holder 5 is elastically biased upward by a biasing force of the compression coil springs 50 relative to the carriage 19.

Mounting members 51 and 52 provided for mounting the movable cylindrical portion 46, the pressing device 47 and the like are fixed to the middle portion of the holder body 45 by screws 54a and 54b respectively, as shown in FIG. 3. The lower mounting member 521s provided with a cylindrical portion 52a (see FIG. 4) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end on which a flange 46a supported on an upper end of the cylindrical portion 52a is formed so as to expand radially outward. A spring shoe 46b is provided on an upper end of the flange 46a. A compression coil spring 53 is interposed between the upper mounting member 51 and the spring shoe 46b of the movable cylindrical portion 46 as shown in FIG. 4. The compression coil spring 53 biases the movable cylindrical portion 46 (the cutter 4) to the lower object 6 side while allowing the upward movement of the movable cylindrical portion 46 against the biasing force when an upward force acts on the cutter 4.

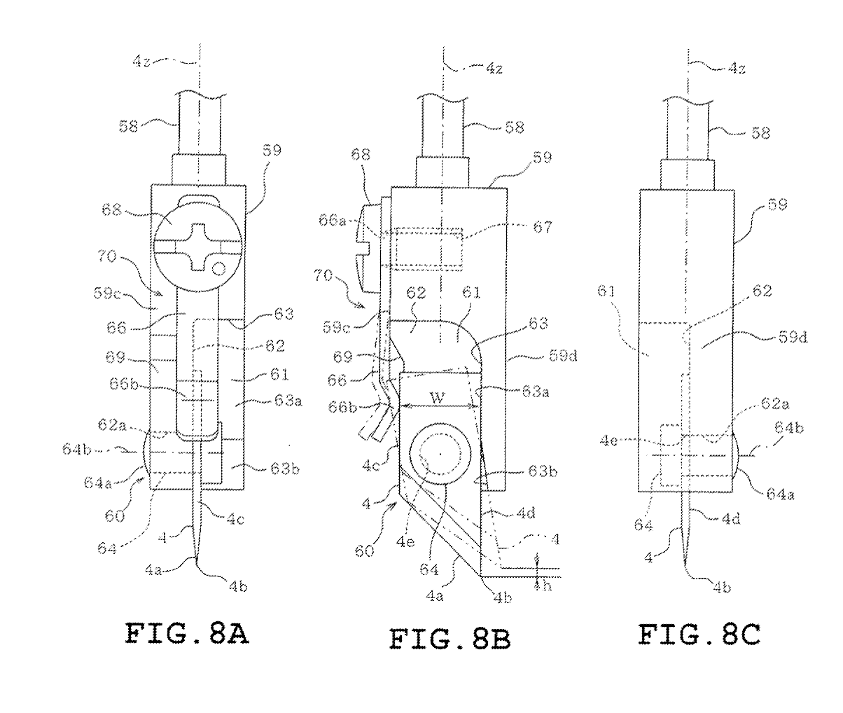

A cutter shaft 58 extends through the movable cylindrical portion 46 in an axial direction of the latter. The cutter shaft 58 is formed into the shape of a long round bar and is longer than the movable cylindrical portion 46. The cutter shaft 58 has a lower end having a mounting member 59 to which the cutter 4 is to be mounted. The cutter 4 has a blade 4a which is titled relative to the object 6. The cutter 4 has a lowermost blade edge 4b which is formed so as to assume a position shifted from a central axis 4z of the cutter shaft 58 (see FIGS. 8B and 9A).

The movable cylindrical portion 46 has two bearings mounted on inner upper and lower ends thereof respectively. The cutter shaft 58 is mounted on the bearings 55 so as to be rotatable about the vertical central axis 4z, that is, a Z-axis as shown in FIG. 4. The cutter 4 presses the blade edge 4b against the X-Y plane or the surface of the object 6 from the Z direction perpendicular to the X-Y plane. Furthermore, the cutter 4 has a height that is set so that when the cutter holder 5 has been moved to the lowered position, the blade edge 4c passes through the object 6 on the holding sheet 10 but does not reach the upper surface of the plate member 3b of the platen 3, as shown in FIG. 9A. On the other hand, the blade edge 4c of the cutter 4 is moved upward with movement of the cutter holder 5 to the raised position, thereby being spaced from the object 6 (see FIG. 4).

The mounting member 52 has three guide holes 52b, 52c and 52d (see FIGS. 2 to 5) which are formed at regular intervals in a circumferential edge of the lower end of the cylindrical portion 52a. A pressing member 56 is disposed under the cylindrical portion 52a and has three guide bars 56b, 56c and 56d which are to be inserted into the guide holes 52b to 52d respectively. The pressing member 56 includes a lover part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56a which vertically extends to cause the blade 4a to protrude downward therethrough. The pressing portion body 56a has an underside serving as a contact surface 56f which is brought into contact with the object 6 around the blade 4a. The contact portion 56f is formed into an annular horizontal flat surface and is brought into surface contact with the object 6. The contact portion 56f is made of a fluorine resin such as Teflon® so as to have a lower coefficient of friction, whereupon the contact portion 56f is rendered slippery relative to the object 6.

The pressing portion body 56a has a connection 56g which is formed integrally on the circumferential edge thereof so as to extend forward, as shown in FIGS. 3 to 5 etc. On the other hand, the mounting member 52 has a front mounting portion 52e for the solenoid 57, integrally formed therewith. The front mounting portion 52e is located in front of the cylindrical portion 52a and above the connection 56g. The solenoid 57 serves as an actuator for vertically moving the pressing member 56 thereby to press the object 6. The solenoid 57 and the pressing member 56 constitute a pressing device 47 together with a control circuit 71 which will be described later. The solenoid 57 is mounted on the front mounting portion 52e so as to be directed downward. The solenoid 57 includes a plunger 57a having a distal end fixed to an upper surface of the connection 56g. When the solenoid 57 is driven with the cutter holder 5 assuming the lowered position, the pressing member 56 is moved downward together with the plunger 57a thereby to press the object 6 with a predetermined pressure (see FIG. 5). On the other hand, when the plunger 57a is located above during non-drive of the solenoid 57, the pressing member 56 releases the object 6 from application of the pressing force. When the cutter holder 5 is moved to the raised position during non-drive of the solenoid 57 (see two-dot chain line in FIG. 4), the pressing member 56 is completely spaced from the object 6.

The holding sheet 10 has an adhesive layer 10 which holds the object 6, as shown in FIG. 9A. When cut by the cutting apparatus 1, the object 6 is immovably held on the holding sheet 10 by a resultant adhesion force of the adhesive layer 10a and a pressing force of the pressing device 47. The holding sheet 10 serving as a holding member is made of, for example, a synthetic resin and formed into a flat rectangular plate shape, as shown in FIG. 1. The adhesive layer 10a is formed by applying an adhesive agent to an upper side of the holding sheet 10, that is, a side thereof opposed to the cutter 4. The sheet-like object 6 such as paper, cloth or resin film is removably held by the adhesive layer 10a. The adhesive layer 10a has an adhesion that is set to a small value such that the object 6 can easily be removed from the adhesive layer 10a without breakage of the object 6.

The cutting apparatus 1 according to the embodiment includes an angle change unit 60 which changes an angle made by the blade 4a of the cutter 4 and the object 6, between a non-cutting time and a cutting time. The following will describe a mounting structure of the angle change unit 60 and the cutter 4 with reference to FIGS. 8 to 8C. Firstly, the cutter 4 is formed of a flat plate-shaped metal, for example, and has the shape of a right-angled trapezium (see FIG. 8B). The cutter 4 has a lengthwise end formed with the diagonal blade 4a for cutting the object 6. The cutter 4 has right and left sides 4c and 4d formed into parallel opposite sides. The side 4d has a lowermost end corner serving as an acutely-formed blade edge 4b of the blade 4a. The cutter 4 has a circular through hole 4e formed in a lengthwise middle thereof.

The cutter 4 includes a mounting member 59 which is secured to a lower end of the cutter shaft 58 and formed into the shape of a generally rectangular block extending downward. The mounting member 59 has a lower half which is cut off into a substantially inverted L-shape except for one side 59d (a right side as viewed in FIG. 8) thereby to be formed into a mounting recess 61. In this case, the mounting recess 61 has a vertical plane 62 which is perpendicular to the X-Y plane and serves as a mounting surface for the cutter 4 located substantially on the central axis 4z of the cutter shaft 58 (see FIG. 8C). The mounting member 59 has a through hole 62a extending through a part thereof located slightly lower than the mounting surface 62. The cutter 4 is swingably mounted to the mounting surface 62 by a rivet 64 serving as a support shaft while the blade 4a is directed downward and extends along the mounting surface 62. In this case, the rivet 64 is in turn inserted through the through hole 4e of the cutter 4 and a through hole 62a of the mounting hole 62 and has a distal end crimped and spread to be formed into a locking end 64a. As a result, the rivet 64 is mounted so that a central axis 64b thereof is perpendicular to the central axis 4z of the cutter shaft 58.

The mounting recess 61 includes an inverted L-shaped inner wall 63 formed with a pair of abutments 63a and 63b capable of abutting against one side 4d of the cutter 4. The first abutment 63a is a vertically extending surface of the inner wall 63, and the second abutment 63b is a tilted surface that is continuous to the lower side of the first abutment 63a and is tilted a predetermined angle relative to the vertical surface of the first abutment 63a. As a result, when the cutter 4 is rotated about the rivet 64 alone the mounting surface 62, an angle made by the blade 4a and the object 6 is changed between a first angle α₁ (see FIG. 9A) at which the side 4d of the cutter 4 abuts against the first abutment 63a and a second angle α₂ (see FIG. 9B) at which the side 4d abuts against the second abutment 63b. In this case, the second angle α₂ is set so as to be smaller than the first angle α₁ (α₂<α₁).

A leaf spring 66 is disposed at the other side 59c of the mounting member 59 (at the left side as viewed in FIG. 8B) to elastically bias the other side 4c of the cutter 4. The leaf spring 66 is an elastic member which is formed of a flexible metal material into a band shape extending vertically along the side 59c of the mounting member 59. The leaf spring 66 has an upper portion or a proximal end provided with a screwing hole 66a. The leaf spring 66 has a distal end further having a pressing portion 66b facing the mounting recess 61 and bent to the side 4c side of the cutter 4.

The mounting member 59 has an upper side part 59c in which a screw hole 67 is formed. A screw 66 having been inserted through the hole 66a is further threadingly inserted into the screw hole 67, whereby the leaf spring 66 is mounted on the mounting member 59. The mounting member 59 has a lower side part 59c with a concave wall 69 formed by concaving the mounting recess 61 so that the mounting recess 61 has a width smaller than the width W of the cutter 4. As a result, the pressing portion 66b of the leaf spring 66 is normally in abutment with the side 4c of the cutter 4, whereby the cutter 4 is elastically biased in such a direction that the blade 4a makes the first angle α₁ with the object 6.

When the blade 4a of the cutter 4 makes the first angle α₁ with the object 6, the lowermost end blade edge 4b assumes a position shifted by distance d1 from the central axis 4z of the cutter shaft 58 and the cutter 4 assumes an initial position where the whole cutter 4 extends vertically, as shown in FIG. 9A. The leaf spring 66 has an elastic force that is set so that the blade 4a is changed from the first angle α₁ to the second angle α₂ by a resistance force (that will be referred to as “cutting resistance force”) the cutter 4 receives from the object 6 with relative movement of the cutter 4 during cutting, as will be described in detail later. When the blade 4a is changed to the second angle α₂, the whole cutter 4 assumes a tilted position such that an offset from the central axis 4z of the cutter shaft 58 assumes a value d₂ (see FIG. 9B). Furthermore, the cutter 4 rotatable about the central axis 4z receives the cutting resistance force during cutting to automatically change its direction in the direction of relative movement of the cutter 4, that is, along a line segment composing the cutting line.

The above-described mounting member 59, the leaf spring 66, the rivet 64, the abutments 63a and 63b and the like constitute an angle change unit 60. Furthermore, the leaf spring 66 and the first abutment 63a serve as a first angle maintenance unit 70 that is configured to maintain the cutter 4 at the first angle. Since the mounting member 59 employed in the embodiment limits swing of the cutter 4 using the inner walls 62 and 63 of the mounting recess 61, the configuration of the angle change unit 60 can be rendered simpler and more compact.

The arrangement of the control system of the cutting apparatus 1 will now be described with reference to a block diagram of FIG. 7. A control circuit (a control unit) 71 controlling the entire cutting apparatus 1 is mainly composed of a computer (CPU). A ROM 72, a RAM 73 and an external memory 74 each serving as a storage unit are connected to the control circuit 71. The ROM 72 stores a cutting control program for controlling the cutting operation, various control data and the like. The RAM 73 is provided with storage areas for temporarily storing various data and program necessary for execution of each processing. The external memory 74 stores pattern cutting data for a plurality of patterns. The aforementioned cutting data includes data of n-number of line segments L₁ to Lₙ composing the cutting line L.

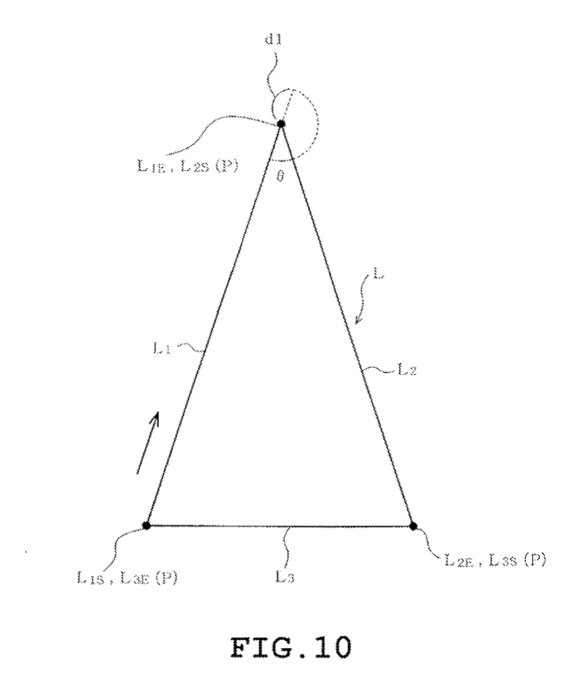

A triangle is to be cut out of the object 6 that is a sheet, such as paper, held on the holding sheet 10, for example, as shown in FIG. 10. In this case, the cutting data includes data of three line segments L₁ to L₃ composing the cutting line. More specifically, the line segments L₁ to L₃ have starting points L_{1S} to L_{3S} and ending points L_{1E} to L_{3B} respectively. Furthermore, since the line segments L₁ to L₃ are continuous and constitute a closed cutting line L, the starting point of each line segment corresponds with the ending point of a neighboring line segment and the ending point of each line segment corresponds with the starting point of a neighboring line segment. The starting and ending points of the line segments L₁ to L₃ are represented by X-Y coordinates.

Operation signals generated by various operation switches 9b are supplied to the control circuit 71. The control circuit 71 controls a displaying operation of the LCD 9a. In this case, while viewing the displayed contents of the LCD 9a, the user operates the switches 9b to select and designate pattern cutting data of a desired pattern. Detection signals are also supplied to the control circuit 71 from various sensors 75 such as a sensor for detecting the holding sheet 10 set from the opening 2a of the cutting apparatus 1. To the control circuit 71 are connected drive circuits 76 to 79 driving the Y-axis, X-axis and Z-axis motors 15, 26 and 34 and the solenoid 57. Upon execution of the cutting control program, the control circuit 71 controls various actuators such as the Y-axis, X-axis and Z-axis motors 15, 26 and 34 and the solenoid 57, based on the cutting data, whereby the cutting operation is automatically executed for the object 6 on the holding sheet 10.

The cutting apparatus 1 constructed and arranged as described above will work as follows. The aforementioned triangle will also be exemplified in the following description, and commonly-used paper will be used as the object 6. The cutter holder 5 assumes the raised position (see FIG. 4) before the cutting apparatus 1 starts cutting the object 6. In this state, the user applies the object 6 to the adhesive layer 10a so that the object 6 is held by the holding sheet 10. The holding sheet 10 is then set to the cutting apparatus 1 through the opening 2a. When the user selects a desired one of the cutting data stored on the external memory 74, for example, the selected cutting data is read to be stored on a memory of the RAM 73. Upon operation of the operation switches 9b, the control circuit 71 starts a cutting operation based on the supplied operation signals.

In the cutting operation, the X-axis and Y-axis motors 26 and 15 are driven to relatively move the cutter 4 so that the blade edge 4b of the cutter 4 assumes the X-Y coordinates (see FIG. 10) of the starting point L_{1S} of line segment L₁. In this state, the solenoid 57 is then driven to cause the pressing member 56 to press the object 6. Furthermore, the Z-axis motor 34 is driven to move the cutter holder 5 to the lowered position, so that the blade edge 4b of the cutter 4 passes trough the object 5 at the starting point L_{1S}. In this case, the cutter 4 is retained in the initial position during the non-cutting time by the elastic force of the leaf spring 66, so that the blade 4a makes the first angle α1 with the object 6 as shown in FIG. 9A. Accordingly, the blade edge 4b of the cutter 4 can be pressed against the object 6 thereby to smoothly snick the object 6.

The motors 15 and 26 are then driven so that cutting is started by moving the cutter 4 and the object 6 relative to each other toward the coordinate of the ending point L_{1E} of the line segment L₁. In the cutting, the blade edge 4b of the cutter 4 is subjected to the cutting resistance force from the object 6. The cutting resistance force causes the cutter 4 to assume a tilted position against the elastic force of the leaf spring 66 such that the angle made by the blade 4a and the object 6 is changed from the first angle α₁ to the second angle α₂.

In this case, furthermore, since the cutter 4 is rotated about the central axis 64b such that the blade edge 4b is slightly moved upward, the Z-axis motor 34 is driven so that the cutter 4 is controlled to be moved downward by an amount of the upward movement of the blade edge 4b (shown as distance h in FIGS. 8B, 9A and 9B). As a result, the blade edge 4b is maintained in a state where the blade edge 4b has passed through the object 6, and the cutting is executed under the condition where the angle made by the blade edge 4b and the object 6 is set to the second angle α₂ that is smaller then the first angle α₁.

When the object 6 is cut along the cutting line L₁ toward the apex P (L_{1E}) in FIG. 10, the blade edge 4b of the cutter 4 is offset by distance d₂ from the central axis 4z of the cutter shaft 58 as described above. When the blade edge 4b has reached the apex P (the ending point L_{1E}), the cutting is interrupted in order that the direction of the blade edge 4b may be changed at point P. In this case, the central axis 4z of the cutter shaft 58 located distance d₂ away from the apex P that is an extension of the line segment L₁ in FIG. 10. Accordingly, the cutter shaft 56 is moved (returned) in the opposite direction by distance d₃ (d₃-d₂-d₁). In this case, the blade edge 4b is moved upward by distance h. As a result, the cutter 4 is returned the initial position by the elastic force of the leaf spring 66 (see FIG. 9A), whereby the angle made by the blade 4a and the object 6 is changed to the first angle α₁. The central axis 4z is located distance d₁ away from the apex P that is the extension of the line segment L₁ in FIG. 10.

Then, in order that the direction of the blade 4b may be changed so that the blade 4b is directed along the line segment L₂, the cutter 4 is moved so that the central axis 4z conforms with the broken line (arc). In this case, since the blade edge 4b slightly bites into the holding sheet 10 through the object 6, the portion of the apex P of the cutting line L is slightly pried or kinked. However, since the cutter 4 is retained in the initial position where the angle made by the blade 4a and the object 6 is the first angle α₁, the direction of the blade 4a can be more easily changed while an area to be pried can be rendered as small as possible. Thus, after the direction of the blade edge 4b has been changed so as to conform with the line segment L₂, the cutting of the line segment L₂ is carried out in the same manner as in the case of the above-described line segment L₃ while the angle made by the blade 4a and the object 6 is changed to the second angle α₂. The cutting of the line segment L₁ is also carried out in the same manner as in the cases of the line segments L₁ and L₂ with the use of the second angle α₂.

When the line segments of the cutting line L include a gentle curve having a large curvature radius, differing from the triangle in FIG. 10, the direction of the blade edge 4b is automatically changed so as to conform with the relative movement of the cutter 4 and accordingly, the cutting is carried out with the use of the second angle α₂ in the same manner as of the line segments L₁ to L₃.

Upon completion of the cutting, the user removes the object 6 from the holding sheet 10. During the cutting, the solenoid 57 is driven so that the object 6 is pressed by the contact surface 56f, and the object 6 can be held by the adhesion of the adhesive layer 10a of the holding sheet 10 so as not to be displaced. Furthermore, the pressing member 56 is moved relative to the object 6 in the cutting. However, since the contact surface 56f of the pressing member 56 is formed of a material with a low friction coefficient, the friction caused between the contact surface 56f and the object 6 can be reduced as much as possible. Consequently, the object 6 can also be prevented from displacement due to the frictional force. Accordingly, the abject 6 can be held more reliably and an accurate cutting line can be formed.

The cutting apparatus 1 according to the above-described embodiment is provided with the angle change unit 60 which changes the angle of the blade 4a of the cutter between the first angle α₁ in the non-cutting time and the second angle α₂ at which the cutter 4 is tilted so that the angle of the blade 4a is rendered smaller than the first angle α₁ during the cutting.

According to the above-described configuration, since the angle of the blade 4a is changed from the first angle α₁ to the second angle α₂ by the angle change unit 60 during the cutting, the angle of the blade 4a is rendered smaller. As a result, the cutting resistance force to which the cutter 4 is subjected from the object 6 can be rendered smaller, whereupon the sharpness of the cutter 4 can be improved. Furthermore, when the cutter 4 is not relatively moved in the non-cutting time, the angle made by the blade 4a and the object 6 can be increased to the first angle α₁ by the angle change unit 60. Accordingly, for example, when a corner of the cutting line is to be cut, the relative movement of the cutter 4 is once stepped at the apex P of the corner, so that the angle made by the blade 4a and the object 6 is changed to the first angle α₁, whereby the direction (cutting direction) of the cutter 4 can easily be changed and the relative movement of the cutter 4 can suitably be carried out.

The angle change unit 60 is provided with the first angle maintenance unit 70 that is configured to maintain the cutter 4 at the first angle during the non-cutting time. As a result, since the cutter 4 is retained in the state where the angle made by the blade 4a and the object 6 is larger, the blade edge 4b of the cutter 4 can be pressed against the object 6 thereby to smoothly snick the object 6.

The first angle maintenance unit 70 includes the elastic member that is configured to elastically bias the cutter 4 in such a direction that the angle made by the blade 4a and the object 6 is the first angle α₁. Consequently, the blade 4a can be maintained at the first angle α₁ by a simple configuration of the elastic member.

The elastic member has an elastic force that is set so that the blade 4a is changed from the first angle α₁ to the second angle α₂ by a resistance to which the blade 4a is subjected with relative movement of the cutter 4 during the cutting period. Accordingly, no means for change the angle made by the blade 4a and the object 6 needs to be separately provided, whereupon the configuration of the angle change unit 60 can be rendered highly simple.

The angle change unit 60 includes a support shaft the rivet 64) which supports the cutter 4 so that the cutter 4 is swingable between the first and second angles α₁ and α₂, the mounting member 59 which fixes the support shaft, the first abutment 63a which limits the swing of the cutter 4 when the angle made by the blade 4a and the object 6 is the first angle α₁, the second abutment 63b which limits the swing of the cutter 4 when the angle made by the blade 4a and the object 6 is the second angle α₂, and the elastic member which is provided between the mounting member 59 and the cutter 4 to elastically bias the cutter 4 in such a direction that the cutter 4 abuts against the first abutment 63a during the non-cutting time.

According to the above-described configuration, when the cutter 4 is abutted against the first or second abutment 63a or 63b, the cutter 4 can be held in the tilted state with the angle made by the blade 4a and the object 6 being the first or second angle α₁ or α₂ during the non-cutting time. Furthermore, the change in the angle of the cutter 4 can be realized by a simple configuration using the mounting member 59 having the abutments 63a and 63b, the support shaft supporting the cutter 4 and the elastic member. Still furthermore, the blade 4a is changed from the first angle α₁ to the second angle α₂ by the cutting resistance force to which the cutter 4 is subjected from the object 6, against the elastic force of the elastic member. Accordingly, the configuration for chancing the angle of the cutter 4 can be rendered further simpler.

The foregoing embodiment should not be restrictive but may be modified or expanded as follows. The embodiment may be applied to various types of devices and apparatus each having a cutting function as well as the cutting apparatus serving as the cutting plotter.

The elastic member may be a torsion spring or a rubber member having a predetermined elasticity, instead of the leaf spring 66. The support shaft swingably supporting the cutter 4 may be a shoulder screw, instead of the rivet 64. More specifically, the shoulder screw includes a head, a thread and a shaft provided between the head and the thread, although not shown. The screw shaft has a larger diameter than the screw thread such that the shoulder screw is stepped. The shoulder screw is inserted through the insertion hole 4e of the cutter 4 to the screw shaft, and the screw thread is threadingly engaged with an inner thread (not shown) formed on the mounting member 59. As a result, the shoulder screw serves as a support shaft which supports the cutter 4 by the screw shaft thereof so that the cutter 4 is swingable.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus in which a cutting blade and an object to be cut are moved relative to each other based on cutting data set therein so that the object is cut into a desired shape by the cutting blade, the apparatus comprising:
an angle change unit which is configured to change an angle made by the cutting blade and the object,
wherein the angle change unit is configured to change the angle between a first angle during a non-cutting time and a second angle at which the cutting unit is tilted during a cutting time so that the second angle is rendered smaller than the first angle.

2. The apparatus according to claim 1, wherein the angle change unit includes a first angle maintenance unit which maintains the cutting blade at the first angle during the non-cutting time.

3. The apparatus according to claim 2, wherein the first angle maintenance unit includes an elastic member which elastically biases the cutting blade in such a direction that the first angle is made by the cutting blade and the object.

4. The apparatus according to claim 3, wherein the elastic member has an elastic force set so that the cutting blade is changed from the first angle to the second angle by a resistance to which the object is subjected from the object during the cutting time.

5. The apparatus according to claim 1, wherein the angle change unit includes:
a support shaft which supports the cutting blade between the first and second angles so that the cutting blade is swingable;
a mounting member which fixes the support shaft;
a pair of first and second abutments which are mounted on the mounting member so as to be capable of abutting against the cutting blade, the first abutment limiting the swinging movement of the cutting blade when abutting against the cutting blade while the first angle is made by the cutting blade and the object, the second abutment limiting the swinging movement of the cutting blade when abutting against the cutting blade while the second angle is made by the cutting blade and the object; and
an elastic member which is provided between the mounting member and the cutting blade to elastically bias the cutting blade in a direction such that the cutting blade abuts against the first abutment during the non-abutting period,
wherein the angle between the cutting blade and the object is changed from the first angle to the second angle by a resistance to which the object is subjected from the object during the cutting time with the relative movement of the cutting blade during the cutting time.
